(19) United States
(12) Patent Application Publication
(10) Pub. No.: US 2016/0329550 A1
(43) Pub. Date: Nov. 10, 2016

(54) BATTERY CELL WITH SURGE PROTECTOR

(71) Applicant: ROBERT BOSCH GMBH, Stuttgart (DE)

(72) Inventor: Markus KOHLBERGER, Stuttgart (DE)

(21) Appl. No.: 15/110,256

(22) PCT Filed: Dec. 30, 2014
(86) PCT No.: PCT/EP2014/079412

§ 371 Date: Jul. 7, 2016

(30) Foreign Application Priority Data
Jan. 9, 2014 (DE) 102014200202.8

(51) Int. Cl. H01M 2/34; H01M 2/12

(52) U.S. Cl. CPC H01M 2/345; H01M 2/1241; H01M 2200/20

(57) ABSTRACT

The invention relates to a battery cell (1) comprising a cell housing (2), a first electrode with a first polarity, a second electrode with a second polarity, and a surge protector for forming a short-circuit between the first electrode and the second electrode. The surge protector comprises a first contact element (6), which is inserted into an opening (9) of the cell housing (2) and which is connected to the first electrode in an electrically conductive manner, and a second contact element (7) at a distance from the first contact element (6), said second contact element being connected to the second electrode in an electrically conductive manner. The first contact element (6) is designed to contact the second contact element (7) in an electrically conductive manner in order to form a short-circuit between the first electrode and the second electrode if a cell housing internal pressure (13) exceeds a surrounding pressure by a first threshold. Furthermore, the first contact element (6) is designed to at least partly release the opening (9) of the cell housing (2) if a cell housing internal pressure (13) exceeds a surrounding pressure by a second threshold.

### BACKGROUND OF THE INVENTION

The invention relates to a battery cell comprising a cell housing, a first electrode having a first polarity, a second electrode having a second polarity and a surge protector for forming a short circuit between the first electrode and the second electrode, wherein the surge protector comprises a first contact element that is inserted into an opening of the cell housing, said contact element being connected to the first electrode in an electrically conductive manner, and a second contact element that is spaced apart from the first contact element, said second contact element being connected to the second electrode in an electrically conductive manner, wherein the first contact element is embodied so as to contact the second contact element in an electrically conductive manner so as to form a short circuit between the first electrode and the second electrode if a cell housing interior pressure exceeds an ambient pressure by a first threshold value.

Battery cells, in particular rechargeable lithium ion cells, are of great importance as energy storage devices, particularly in the field of electric mobility. Typically, a plurality of battery cells is electrically connected to one another to form one or multiple battery modules. In order to protect the battery cells against outside influences, in particular against moisture, the individual battery cells are typically surrounded in each case by a metal cell housing that is essentially closed in a gas-tight manner.

In the case of battery cells of this type, in particular in the case of rechargeable lithium ion cells, it is problematic that, in the case of the battery cells heating up above a critical temperature value, it can lead to the battery cells experiencing a so-called leakage of gas. Faults such as a short circuit between the electrodes of a battery cell, overcharging the battery cell during a charging procedure or an extremely high ambient temperature can lead to the battery cell heating up to a critical extent. As a consequence of a battery cell of this type heating up to a critical extent, it is possible for undesired chemical reactions to occur in the battery cell and said undesired chemical reactions can lead to a so-called thermal runaway. In particular, the electrolyte that is required for the transport of ions between the electrodes of a battery cell can corrode as a consequence of the critical heating and transition into a gaseous state. As a result of this buildup of gas, a high pressure occurs within the battery cell in a short period of time. In order to prevent the battery cell from bursting owing to the intense increase in pressure, it is known in particular in the case of lithium ion cells to fit said cells with a safety valve. It is possible by way of the safety valve for a gas that has built up within the battery cell and also where appropriate further products of corrosion to escape as a fluid, in particular as a gas and/or aerosol. A lithium ion cell having a safety valve of this type is disclosed by way of example in the publication DE 103 28 862 B4.

Furthermore, in order to prevent such a buildup of gas in the case of a rechargeable battery cell as a consequence of overcharging the battery cell, battery cells that are mentioned in the introduction are known, said battery cells comprising a surge protector, also known as an “overcharge safety device” (OSD). A battery cell having a surge protector is disclosed by way of example in the publications DE 10 2011 002 659 A1 and DE 10 2012 200 868 A1.

A membrane that is inserted in the cover of a cell housing of a battery cell is in particular known as a surge protector, said membrane being connected to the positive pole of the battery cell in an electrically conductive manner. The membrane is arched in the correct state into the cell housing. If the pressure in the battery cell increases, the membrane is pressed outwards and contacts a contact bridge in an electrically conductive manner, said contact bridge being arranged on the negative pole of the battery cell. The electrically conductive connection between the membrane and the contact bridge that is achieved in this manner has a lower electrical resistance than the chemically active part of the cell, the so-called “jelly roll”, whereby the electrical current no longer flows through the battery cell but rather by way of the cell housing of the battery cell, in other words forming a short circuit. The short circuit current that flows by way of the cell housing can destroy the membrane. In order to prevent this, it is known to install a fuse in the connection from the jelly roll to the negative pole or to the cell housing and said fuse interrupts this short circuit current before the membrane is destroyed.

The procedure of providing a battery cell with safety functions of this type is associated with time and cost expenditure during production.

### SUMMARY OF THE INVENTION

Against this background, the object of the invention is to improve a battery cell that is mentioned in the introduction, in particular to the effect that it is possible to save costs when providing the above mentioned safety functions when producing a battery cell of this type.

In order to achieve the object, a battery cell is proposed that comprises a cell housing, a first electrode having a first polarity, a second electrode having a second polarity and a surge protector for forming a short circuit between the first electrode and the second electrode, wherein the surge protector comprises a first contact element that is inserted into an opening of the cell housing, said first contact element being connected to the first electrode in an electrically conductive manner, and a second contact element that is spaced apart from the first contact element and is connected to the second electrode in an electrically conductive manner, wherein the first contact element is embodied so as to contact the second contact element in an electrically conductive manner so as to form a short circuit between the first electrode and the second electrode if a cell housing interior pressure exceeds an ambient pressure by a first threshold value, and the first contact element is in addition embodied so as to at least in part release the opening of the cell housing if a cell housing interior pressure exceeds an ambient pressure by a second threshold value. In particular, it is provided that the battery cell is a rechargeable lithium ion cell. In addition, it is in particular provided that the battery cell is embodied as a prismatic cell. The cell housing of the battery cell is preferably a metal cell housing, wherein the cell housing preferably comprises a cell housing cover by means of which the cell housing is advantageously essentially closed in a gas-tight manner. In particular, it is provided that the first contact element is a pressure-sensitive element, in particular a valve or a membrane.

In the case of the battery cell in accordance with the invention, the functionality of a surge protector is advantageously combined with the functionality of a safety valve so as to protect the battery cell from a damaging excess pressure in a component. With the present invention, a battery cell is consequently advantageously provided, said battery cell comprising a single-part embodiment of a pressure release device having a surge protector. As a consequence, costs can be saved during production, in particular since it is advantageously not required as a result of the embodiment of the battery cell in accordance with the invention to provide an additional safety valve in the cell housing. The necessary working steps for integrating a safety valve of this type are advantageously omitted, whereby is it possible to achieve a reduction in costs when producing a battery cell of this type. Furthermore, advantageously less surface space is required by a battery cell housing as installation space. As a consequence, there are further advantages by way of example regarding the electrical interconnection of multiple battery cells.

In accordance with one particularly preferred embodiment of the present invention, it is provided that the first contact element is embodied in such a manner that the second threshold value is greater than the first threshold value. In the case of an embodiment of this type, the first contact element advantageously changes its original position in the case of an increase in pressure in the battery cell housing in such a manner that the first contact element contacts the second contact element in an electrically conductive manner so as to form a short circuit between the first electrode and the second electrode of the battery cell if the cell housing interior pressure exceeds the ambient pressure outside the cell housing by the first threshold value. If the pressure further increases in the cell housing so that the cell housing interior pressure exceeds the ambient pressure outside the cell housing by a second threshold value that is greater than the first threshold value, the first contact element thus advantageously at least in part releases the opening of the cell housing, the first contact element being arranged in said opening. It is thus then possible for the pressure to be equalized by way of the at least in part released opening of the cell housing. In addition, any gas that has built up in the cell housing can advantageously escape the cell housing by way of the opening that has been at least in part released by the contact element.

In accordance with one advantageous embodiment of the battery cell in accordance with the invention, it is provided that the first contact element is embodied in such a manner that the first threshold value lies between 0.1 MPa (MPa: Megapascal) and 0.3 MPa. It is particularly preferably provided that the first threshold value is approximately 0.2 MPa. Since the ambient pressure is typically a pressure of approximately 0.1 MPa, the first contact element will then advantageously contact the second contact element if the pressure within the cell housing exceeds the value of approx. 0.3 MPa.

A further advantageous embodiment of the battery cell in accordance with the invention provides that the first contact element is embodied in such a manner that the second threshold value lies between 0.3 MPa and 0.5 MPa. It is particularly preferably provided that the second threshold value is approximately 0.4 MPa. In the case of a typically prevailing ambient pressure of approximately 0.1 MPa, the contact element also releases the opening of the cell housing in the case of an embodiment of this type if the cell housing interior pressure exceeds a pressure of 0.5 MPa.

In accordance with a particularly advantageous embodiment of the battery cell in accordance with the invention, the first contact element comprises at least one predetermined breaking point that is embodied in such a manner that it breaks if a cell housing inner pressure exceeds an ambient pressure by the second threshold value. The first contact element advantageously at least in part releases the housing opening by means of the said predetermined breaking point breaking. In particular, it is provided that the first contact element breaks in the region of the predetermined breaking point so that the cell housing opening in which the contact element is arranged is in part released. It is then advantageously possible for the pressure to be equalized and/or for a buildup of gas within the cell housing to escape by way of the at least in part released cell housing opening. In particular, it is provided that the predetermined breaking point is embodied in such a manner that the first contact element is furthermore contacted in an electrically conductive manner by the second contact element in the case of the first contact element breaking in the region of the predetermined breaking point so that furthermore an electrical current can flow by way of the electrically conductive connection between the first contact element and the second contact element.

In accordance with a further particularly advantageous embodiment of the battery cell in accordance with the invention, it is provided that the first contact element is a membrane having an electrically conductive contact region, wherein the membrane is embodied in such a manner that the contact region of the membrane contacts the second contact element in an electrically conductive manner if a cell housing interior pressure exceeds an ambient pressure by the first threshold value. In particular, it is provided that the membrane is embodied from an electrically conductive material. The contact region of the membrane is in particular the region of the membrane that contacts the second contact element in an electrically conductive manner if the cell housing interior pressure exceeds the ambient pressure by the first threshold value.

A further advantageous embodiment of the battery cell in accordance with the invention provides that the membrane is arched into the interior of the cell housing, preferably in a convex manner into the interior of the cell housing, wherein in the case of an increase in the cell housing interior pressure, the membrane arches outwards in such a manner that the membrane arches outwards and contacts the second contact element in an electrically conductive manner if a cell housing interior pressure exceeds an ambient pressure by the first threshold value. In particular, it is provided that the first contact element is arched outwards in a convex manner if said contact element contacts the second contact element in an electrically conductive manner. In particular, it is provided that the first contact element is arched under mechanical stress into the interior of the cell housing, wherein it is provided that the membrane remains arched inwards until the first threshold value is exceeded, in other words that essentially the membrane is not mechanically deformed but rather that in the case of the second threshold value being exceeded, the membrane almost jumps outwards.

In particular, it is provided that the membrane comprises at least one predetermined breaking point outside the contact region. In the case of the second threshold value being exceeded, the cell housing opening in which the membrane is inserted is in part advantageously released at the predetermined breaking point so that it is rendered possible to equalize the pressure and/or for a buildup of gas to escape from the interior of the cell housing by way of the in part released cell housing opening. The predetermined breaking point is advantageously arranged in such a manner that at least the contact region of the membrane is furthermore contacted by the second contact element in an electrically conductive manner, wherein the contact region furthermore is connected in an electrically conductive manner to the cell housing.

A further advantageous embodiment of the invention provides that the battery cell is connected in the region of the opening of the cell housing to a degassing device, preferably to a degassing duct. It is advantageously possible by way of the degassing device to dissipate in a controlled manner gas that is escaping by way of the at least in part released cell housing opening.

In accordance with a further advantageous embodiment of the invention, it is provided that the battery cell comprises a fuse inside the cell, preferably a safety fuse, which protects the surge protector from a thermal runaway if the first contact element contacts the second contact element in an electrically conductive manner so as to form a short circuit between the first electrode and the second electrode. In particular, it is provided that the fuse is arranged between the cell housing and the so-called jelly roll. The term “jelly roll” is to be understood in particular as wound electrodes having an electrolyte and separator arranged between said wound electrodes.

Furthermore, in order to achieve the object mentioned in the introduction, a battery module is provided that comprises at least one battery cell in accordance with the invention. In particular, it is provided that the battery module comprises a plurality of battery cells in accordance with the invention that are connected to one another in an electrically conductive manner. The battery module advantageously comprises a degassing device, preferably a degassing duct, wherein the battery cells in accordance with the invention having the cell housing openings are advantageously connected to the degassing device.

### BRIEF DESCRIPTION OF THE DRAWINGS

Further advantageous details, features and embodiment details of the invention are further explained in connection with the exemplary embodiments that are illustrated in the drawings. In the drawings:

FIG. 1 illustrates schematically a plan view of an exemplary embodiment for a battery cell in accordance with the invention,

FIG. 2 illustrates schematically a sectional side view of a section of an exemplary embodiment for a battery cell in accordance with the invention,

FIG. 3 illustrates schematically a sectional side view of a section of an exemplary embodiment for a battery cell in accordance with the invention, wherein the cell housing interior pressure has exceeded the ambient pressure by a first threshold value,

FIG. 4 illustrates schematically a sectional side view of a section of an exemplary embodiment for a battery cell in accordance with the invention, wherein the cell housing interior pressure has exceeded an ambient pressure by a second threshold value, and

FIG. 5 illustrates schematically a plan view of an exemplary embodiment for a battery cell in accordance with the invention, wherein the cell housing interior pressure has exceeded an ambient pressure by a second threshold value.

### DETAILED DESCRIPTION

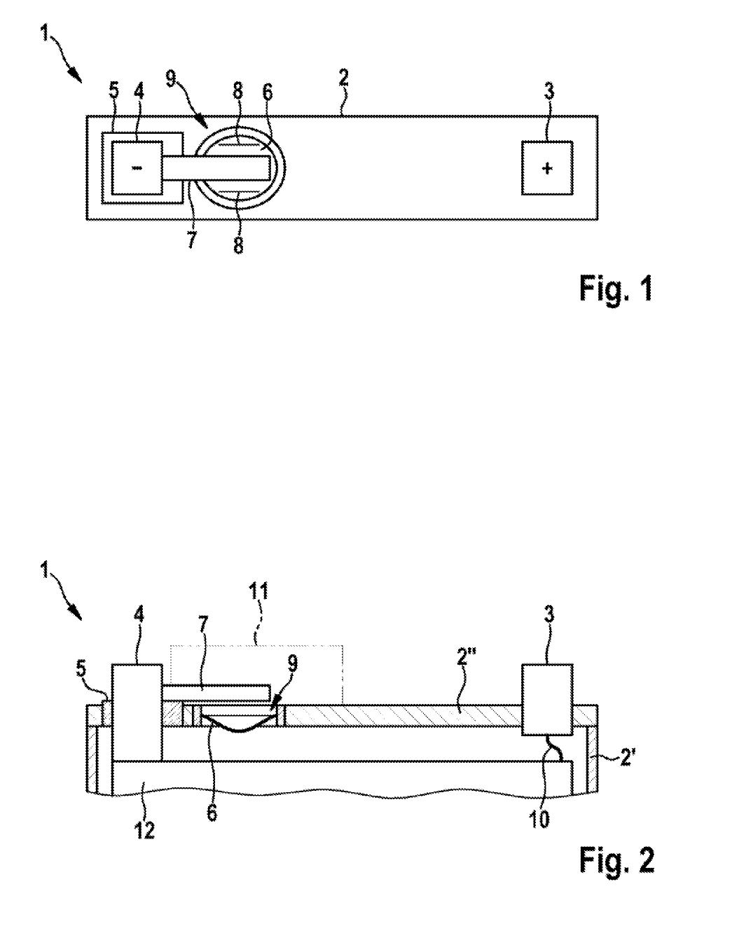

An advantageous embodiment of a battery cell 1 in accordance with the invention is further explained in conjunction with FIG. 1 to FIG. 5. The battery cell 1 can be in particular a rechargeable lithium ion cell. In FIG. 1 to FIG. 5, the battery cell 1 comprises in each case a prismatic cell housing 2. The cell housing 2 is embodied from metal, in particular from stainless steel or an aluminum alloy. The cell housing 2 of the battery cell 1 advantageously prevents moisture from penetrating into the battery cell 1.

In the case of the exemplary embodiments that are illustrated in the figures, the battery cell 1 comprises in each case a first cell terminal 3 and a second cell terminal 4. The first cell terminal 3 is connected to the positive electrode of the battery cell 1 in an electrically conductive manner. The same electrical potential prevails at the cell housing 2 as at the cell terminal 3 of the battery cell 1. The second cell terminal 4 of the battery cell 1 is connected to the negative electrode of the battery cell 1 in an electrically conductive manner and is electrically insulated with respect to the cell housing 2 by means of an insulating element 5.

The battery cell 1 that is illustrated in the figures in addition comprises in each case a surge protector for forming a short circuit between the positive electrode and the negative electrode of the battery cell 1. The surge protector is achieved in such a manner that a first contact element 6 is inserted into a cell housing opening 9, wherein the first contact element 6 is a metal bursting membrane in the exemplary embodiment. A second contact element 7 is furthermore arranged in an electrically conductive manner on the second cell terminal 4, wherein the second contact element 7 is an electrically conductive contact bridge in the exemplary embodiment. During normal operation of the battery cell 1, the first contact element 6 and the second contact element 7 are spaced apart from one another, in other words current cannot flow from the first contact element 6 by way of the second contact element 7. A normal operation is illustrated in FIG. 1.

The first contact element 6 of the battery cell 1 is embodied in such a manner that said first contact element contacts the second contact element 7 in an electrically conductive manner so as to form a short circuit between the positive electrode and the negative electrode of the battery cell 1 if a cell housing interior pressure exceeds an ambient pressure by a first threshold value that is preferably 0.2 MPa. The first contact element 6 arches outwards under the effect of the pressure, wherein the first contact element 6 that is arched outwards contacts the second contact element 7 in the case of the first threshold value being exceeded. The current then no longer flows within the battery cell 1 by way of the chemically active part of the battery cell 1 but rather by way of the cell housing 2 from the positive electrode to the negative electrode.

The region with which the first contact element 6 contacts the second contact element 7 in an electrically conductive manner in the case of the first threshold value being exceeded is the contact region of the first contact element 6, in FIG. 1 therefore the region of the first contact element 6 that is covered by the second contact element 7. Outside the contact region, the first contact element 6 of the battery cell 1 that is illustrated in the figures comprises two predetermined breaking points 8. The predetermined breaking points 8 are embodied in such a manner that the first contact arrangement 6 breaks at these predetermined breaking points 8 and consequently in part releases the cell housing opening 9 if the cell housing interior pressure exceeds the ambient pressure by a second threshold value, wherein the second threshold value is greater than the first threshold value. It is preferred that the second threshold value is 0.4 MPa.

FIG. 2 illustrates the section of an exemplary embodiment for a battery cell 1 in accordance with the invention during normal operation of the battery cell. The cell housing interior pressure corresponds approximately to the ambient pressure, which means in particular that the difference between the cell housing interior pressure and the ambient pressure is smaller than the first threshold value. As is evident in FIG. 2, the cell housing 2 of the battery cell 1 comprises side walls 2′ and a cell housing cover 2″. The cell housing protects in particular the so-called jelly roll 12 against outside influences, in particular against moisture. As is in addition illustrated schematically in FIG. 2, the first cell terminal 3 of the battery cell 1 is connected to the positive electrode of the battery cell 1 in an electrically conductive manner. The second cell terminal 4 of the battery cell 1 is connected to the negative electrode of the battery cell 1 in an electrically conductive manner and is electrically insulated with respect to the cell housing cover 2″ of the battery cell 1 by means of the insulating element 5. A fuse 10 is arranged between the jelly roll 12 and the first cell terminal 3, said fuse advantageously preventing the first contact element 6 from being destroyed if a short circuit current flows by way of said contact element in the function as a surge protector.

As is furthermore evident in FIG. 2, in the case of the illustrated battery cell 1, a first contact element 6 is inserted into the opening of the cell housing, namely into the opening 9 of the cell housing cover 2″, wherein the first contact element 6 is an electrically conductive membrane in the exemplary embodiment. The first contact element 6 is connected to the cell housing cover 2″ in an electrically conductive manner. In the case of the normal operation that is illustrated in FIG. 2, the first contact element 6 is arched towards the interior of the cell housing of the battery cell 1 in a convex manner. The first contact element 6 is spaced apart from the second contact element 7 that is connected in an electrically conductive manner to the cell terminal 4, wherein the second contact element 7 is an electrically conductive contact bridge in the exemplary embodiment. As is in addition illustrated schematically in FIG. 2, the battery cell 1 is connected in the region of the cell housing opening 9 to a degassing duct 11.

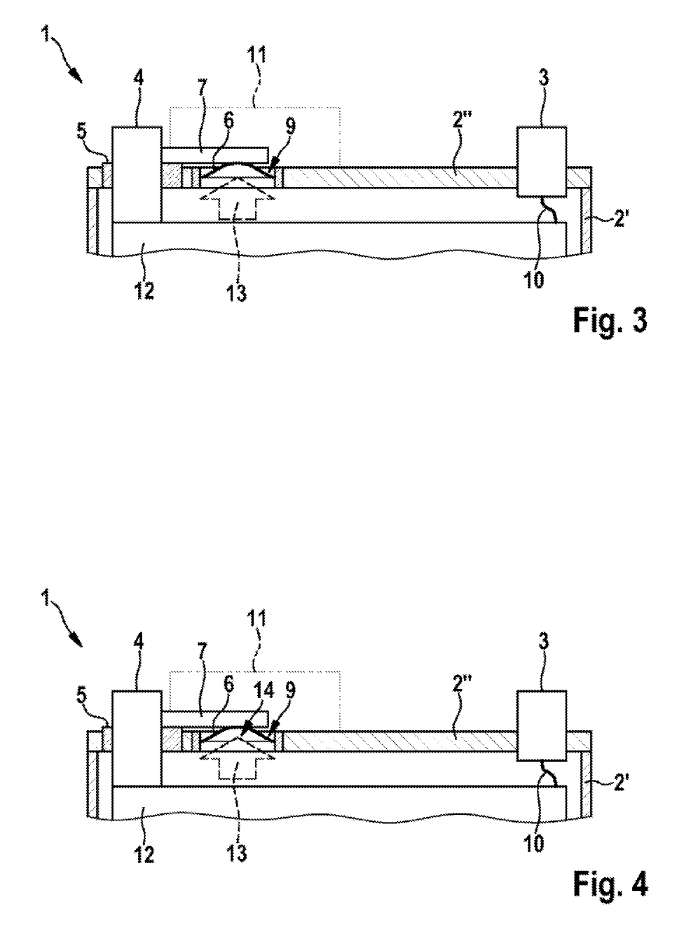

FIG. 3 and FIG. 4 illustrate the battery cell 1 in FIG. 2 outside of normal operation. The cell housing interior pressure is illustrated symbolically by means of the arrow 13.

FIG. 3 illustrates the battery cell 1 in the case of a cell interior pressure 13 that exceeds the ambient pressure by a first threshold value, in particular by a threshold value of 0.2 MPa. The first contact element 6 that is inserted into the opening 9 of the cell housing cover 2″ has arched outwards in a convex manner as a result of the increase in the cell housing interior pressure 13 in such a manner that the contact region of the first contact element 6 contacts the second contact element 7 in an electrically conductive manner and consequently a short circuit is formed between the positive electrode and the negative electrode of the battery cell 1.

FIG. 4 illustrates the battery cell 1 in the case of a further increase in the cell housing interior pressure, wherein the cell housing interior pressure exceeds the ambient pressure by a second threshold value that is greater than the first threshold value. In particular, it is provided that the second threshold value is 0.4 MPa. As is illustrated in FIG. 4, the first contact element 6 furthermore contacts the second contact element 7 so that furthermore the second cell terminal 4 is connected in an electrically conductive manner to the cell housing cover 2″ and consequently to the cell housing of the battery cell 1. Furthermore, predetermined breaking points on the first contact element 6 are broken by means of the second threshold value being exceeded, whereby an opening 14 has formed in the first contact element 6 and the cell housing opening 9 is in part released. A buildup of gas within the cell housing of the battery cell 1 can escape the cell housing of the battery cell 1 by way of this opening 14.

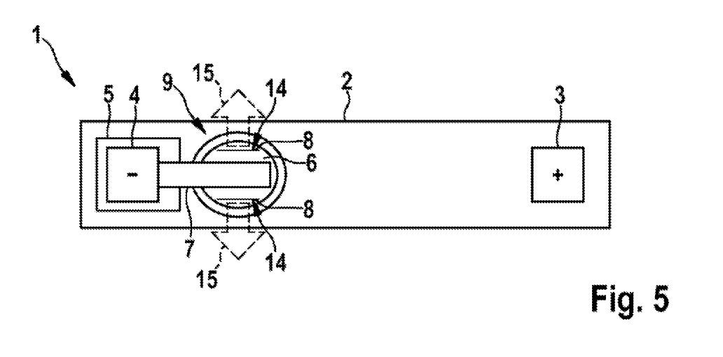

FIG. 5 illustrates in an exemplary manner gas that has built up within the battery cell 1 escaping the cell housing 2 after the predetermined breaking points 8 of the first contact element 6 have broken as a consequence of the second threshold value being exceeded. Openings 14 have formed in the first contact element 6 by means of the predetermined breaking points 8 of the first contact element 6 breaking and this releases in part the cell housing opening 9. A gas that is escaping from these broken predetermined breaking points 8 or the openings 14 that are formed by means of the predetermined breaking points 8 breaking under high pressure is illustrated schematically in FIG. 5 by means of the arrow 15. It is preferably provided that as is illustrated schematically in FIG. 2 to FIG. 4 the battery cell 1 is arranged on a degassing duct 11 so that gas 15 that flows out is dissipated in a controlled manner by the cell housing opening 9 by way of the degassing duct.

In accordance with an advantageous embodiment variant of the invention that is not illustrated, it can be provided that the first contact element 6 of a battery cell 1 comprises a predetermined breaking point on its outer edge so that the first contact element 6 detaches completely from the cell housing opening 9 in the case of the second threshold value being exceeded and the cell housing opening 9 is consequently completely released.

The exemplary embodiments that are illustrated in the figures and explained in conjunction with said figures are used to explain the invention and do not limit said invention.

1. A battery cell (1) comprising a cell housing (2), a first electrode having a first polarity, a second electrode having a second polarity, and a surge protector for forming a short circuit between the first electrode and the second electrode, wherein the surge protector comprises a first contact element (6) that is inserted into an opening (9) of the cell housing (2), said first contact element being connected to the first electrode in an electrically conductive manner, and a second contact element (7) that is spaced apart from the first contact element (6), said second contact element being connected to the second electrode in an electrically conductive manner, wherein the first contact element (6) is configured so as to contact the second contact element (7) in an electrically conductive manner so as to form a short circuit between the first electrode and the second electrode if a cell housing interior pressure (13) exceeds an ambient pressure by a first threshold value, characterized in that the first contact element (6) is in addition configured so as to at least in part release the opening (9) of the cell housing (2) if a cell housing interior pressure (13) exceeds an ambient pressure by a second threshold value.

2. The battery cell (1) as claimed in claim 1, characterized in that the first contact element (1) is configured in such a manner that the second threshold value is greater than the first threshold value.

3. The battery cell (1) as claimed in claim 1, characterized in that the first contact element (6) is configured in such a manner that the first threshold value lies between 0.1 MPa and 0.3 MPa.

4. The battery cell (1) as claimed in claim 1, characterized in that the first contact element (6) is configured in such a manner that the second threshold value lies between 0.3 MPa and 0.5 MPa.

5. The battery cell (1) as claimed in claim 1, characterized in that the first contact element (6) comprises at least one predetermined breaking point (8) that is configured in such a manner as to break if a cell housing interior pressure (13) exceeds an ambient pressure by the second threshold value.

6. The battery cell (1) as claimed in claim 1, characterized in that the first contact element (6) is a membrane having an electrically conductive contact region, wherein the first contact region (6) is configured in such a manner that the contact region of the first contact element (6) contacts the second contact element (7) in an electrically conductive manner if a cell housing interior pressure (13) exceeds an ambient pressure by the first threshold value.

7. The battery cell (1) as claimed in claim 1, characterized in that the first contact element (6) is a membrane, wherein the first contact element (6) is arched into the interior of the cell housing (2) and the first contact element (6) is arched outwards in the case of an increase in the cell housing interior pressure (13) in such a manner that the first contact element (6) that is arched outwards contacts the second contact element (7) in an electrically conductive manner if a cell housing interior pressure (13) exceeds an ambient pressure by the first threshold value.

8. The battery cell (1) as claimed in claim 6, characterized in that the first contact element (6) is a membrane, wherein the first contact element (6) comprises at least one predetermined breaking point (8) outside the contact region.

9. The battery cell (1) as claimed in claim 1, characterized in that the battery cell (1) is connected in a region of the opening (9) of the cell housing (2) to a degassing device (11).

10. The battery cell (1) as claimed in claim 1, characterized in that the battery cell (1) comprises a cell-internal fuse (10) that protects the surge protector against a thermal runaway if the first contact element (6) contacts the second contact element (7) in an electrically conductive manner so as to form a short circuit between the first electrode and the second electrode.

11. The battery cell (1) as claimed in claim 2, characterized in that the first contact element (6) is configured in such a manner that the first threshold value lies between 0.1 MPa and 0.3 MPa.

12. The battery cell (1) as claimed in claim 11, characterized in that the first contact element (6) is configured in such a manner that the second threshold value lies between 0.3 MPa and 0.5 MPa.

13. The battery cell (1) as claimed in claim 12, characterized in that the first contact element (6) comprises at least one predetermined breaking point (8) that is configured in such a manner as to break if a cell housing interior pressure (13) exceeds an ambient pressure by the second threshold value.

14. The battery cell (1) as claimed in claim 13, characterized in that the first contact element (6) is a membrane having an electrically conductive contact region, wherein the first contact region (6) is configured in such a manner that the contact region of the first contact element (6) contacts the second contact element (7) in an electrically conductive manner if a cell housing interior pressure (13) exceeds an ambient pressure by the first threshold value.

15. The battery cell (1) as claimed in claim 14, characterized in that the first contact element (6) is a membrane, wherein the first contact element (6) is arched into the interior of the cell housing (2) and the first contact element (6) is arched outwards in the case of an increase in the cell housing interior pressure (13) in such a manner that the first contact element (6) that is arched outwards contacts the second contact element (7) in an electrically conductive manner if a cell housing interior pressure (13) exceeds an ambient pressure by the first threshold value.

16. The battery cell (1) as claimed in claim 15, characterized in that the first contact element (6) is a membrane, wherein the first contact element (6) comprises at least one predetermined breaking point (8) outside the contact region.

17. The battery cell (1) as claimed in claim 16, characterized in that the battery cell (1) is connected in a region of the opening (9) of the cell housing (2) to a degassing device (11).

18. The battery cell (1) as claimed in claim 17, characterized in that the battery cell (1) comprises a cell-internal fuse (10) that protects the surge protector against a thermal runaway if the first contact element (6) contacts the second contact element (7) in an electrically conductive manner so as to form a short circuit between the first electrode and the second electrode.
